(19) United States
(12) Patent Application Publication
(10) Pub. No.: US 2007/0115420 A1
(43) Pub. Date: May 24, 2007

(54) Liquid crystal display device

(75) Inventors: Hung-Jen Chu, Padeh City (TW); Cheng-Chung Hu, Padeh City (TW); Wen-Hsiung Liu, Padeh City (TW); Hsian-Ching Chiu, Padeh City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Chunghwa Picture Tubes, Ltd., Padeh City (TW)

(21) Appl. No.: 11/284,941

(22) Filed: Nov. 21, 2005

(51) Int. Cl. G02F 1/1339

(52) U.S. Cl. 349/155

(57) ABSTRACT

An LCD device comprises a TFT array substrate, a color filter substrate and a LC layer sandwiched therebetween. On the TFT array and color filter substrates, a plurality of first and second protrusions and spacers are provided, respectively. When the TFT array and color filter substrates are assembled together, each of the plurality of first and second protrusions and a corresponding one of the plurality of first and second spacers are aligned to each other and have a gap provided therebetween, in which the LC layer is positioned where LC material is filled. The plurality of first protrusions and a corresponding one of the plurality of first spacers are brought into contact with each other and the plurality of second protrusions and a corresponding one of the plurality of second spacers are also brought into contact with each other while a space margin is provided therebetween.

### BACKGROUND OF THE INVENTION

1. Field of the Invention

The present invention relates to a liquid crystal display (LCD) device, and particularly to an LCD device in which a thin film transistor (TFT) structure on an array substrate is modified to form a protrusion.

2. Descriptions of the Related Art

For a conventional LCD device, a dispersing spherical spacer process is generally involved in an assembly process with respect to an array substrate and a color filter substrate. However, spray distribution density in the dispersed spherical spacer process is hard to be control. The uneven density of the spherical spacers may have an influence on flatness of the LCD device and thus may affect adversely overall picture frame quality thereof.

In addition, resin based dispersing spherical materials are generally utilized for forming spacers for liquid crystal (LC) cells. Such spherical materials have the disadvantages of being detrimental to alignment layers, causing a poor display and exhibiting light leakage resulting in a low contrast. In view of this problem, spacers on color filters (SOCs) had been developed in replace of the spherical spacers in the color filter industry. Such SOCs may be made in an exposure process with the result of a more uniform thickness and an increased aperture ratio.

Since more uniform LC cell gaps may be obtained when such SOC technology is applied and since an improved transparency and a higher contrast may be achieved for the corresponding LCD device, such SOCs had gradually replaced the spherical spacers. However, additional problems had been introduced into the SOC technology. Process wise, rubbing is unavoidably taken place between the color filter substrate and the array substrate when they are assembled together. In this case, a larger friction force is arisen, leading to an increased process time. Further, the substrates may be scraped, resulting in poor display characteristics. In use, plastic deformity is possible to be induced in the SOCs when an external force exerts thereon. Such deformity may cause that the LC cell gaps may not be restored to their original heights and thus the LCD device may have poor display characteristics. Furthermore, the SOCs have smaller shrinkage than that of the LC material at a lower temperature, resulting in a bubble forming issue on the LC material.

Response to these problems, SOCs of different heights have been developed so as to provide LC cell gaps arranged at different positions in a vertical direction in the LCD device. To form such SOCs of different heights, different thicknesses may be provided for different color layers of the color filters. However, the thicknesses of the different color layers are hard to be control. Alternatively, these different heights of color layers may be obtained through an exposure process for the color filters by controlling the exposure amount. However, such process may involve multiple mask-based processes, which is complex and even time consuming and cost pricy.

### SUMMARY OF THE INVENTION

It is an object of the present invention to provide a liquid crystal display (LCD) device in which platforms of different heights are provided on an array substrate by using a simple mask design so that different predetermined spaces may be provided between the array substrate and a color filter substrate on which spacers (spacers on color filter (SOCs)) are formed. In this manner, the result of different heights of spacers in the conventional LCD device may be equivalently achieved by the provision of the different predetermined spaces between the array and color filter substrates in this invention at the same time the problems and disadvantages encountered in the prior art may be resolved.

To achieve the above object, an LCD device comprises a thin film transistor (TFT) array substrate, a color filter substrate, and a liquid crystal (LC) layer sandwiched therebetween. On the color filter substrate, a plurality of first and second spacers is provided and a plurality of first and second protrusions corresponding to the plurality of first and second spacers is provided respectively on the TFT array substrate. When the TFT array and color filter substrates are assembled together, each of the plurality of protrusions and a corresponding one of the plurality of spacers are aligned to each other and have a gap provided therebetween, in which the LC layer is positioned where LC material is filled. The plurality of first spacers and the plurality of first protrusions are brought into contact with each other and the plurality of second spacers and the plurality of second protrusions are also brought into contact with each other while a space margin is provided between them and the TFT array substrate. With the space margin, bubble forming of the LC material due to shrinkage thereof at a lower temperature may be prevented. Further, the spacers on the color filter substrate may not get deformed when being subject to an external force with the provision of the protrusions on the TFT array substrate.

To enable the above and other objects, constructions and efficacies of the present invention, the present invention will be described in more detail below through the preferred embodiments taken in conjunction with the accompanying drawing.

### BRIEF DESCRIPTION OF THE DRAWINGS

FIG. 1 shows a cross sectional view of a thin film transistor (TFT) structure on an array substrate of a conventional liquid crystal display (LCD) device;

FIG. 2 shows a schematic diagram of assembly of an LCD device according to a first embodiment of the present invention;

FIG. 3 shows a cross sectional view of structure of the LCD device according to the first embodiment of the present invention;

FIG. 4 shows a schematic diagram of assembly of the LCD device according to a second embodiment of the present invention;

FIG. 5 shows a cross sectional view of structure of the LCD device according to the second embodiment of the present invention;

FIG. 6 shows a schematic diagram of assembly of the LCD device according to a third embodiment of the present invention;

FIG. 7 shows a schematic diagram of assembly of the LCD device according to a fourth embodiment of the present invention;

FIG. 8 shows a top view of assembly of the LCD device according to the fourth embodiment of the present invention;

FIG. 9 shows a schematic diagram of the LCD device according to the fourth embodiment of the present invention when being exerted with an external force; and

FIG. 10 shows a top view of assembly of the LCD device according to a fifth embodiment of the present invention.

### DETAILED DESCRIPTION OF THE INVENTION

In principle, since spacers (know as spacers on color filter (SOCs) in the art) are uniformly arranged, the present invention provides protrusions on an array substrate of a liquid crystal display (LCD) device, the protrusions having different areas, shapes and heights, compared with the spacers on a color filter substrate, so as to achieve an equivalent result of the spacers (spacers on color filter (SOCs)) of different heights in the prior art at the same time the problems and disadvantages encountered in the prior art are resolved. In forming such protrusion, when a semiconductor layer or a source and drain layer is to be formed, a mask for forming the semiconductor layer or the source and drain layer is provided with a rectangular opening at a structure corresponding to a gate line on the array substrate so as to additionally form another semiconductor layer or another source and drain layer between a gate insulating layer and a contact hole of the gate line, with a dimension so that the protrusion may sufficiently support a corresponding spacer on the color filter substrate.

As such, number of masks used for forming the array substrate with the protrusions may not be increased and even process time and cost may be saved. The formation of such protrusions will be explained in detail below.

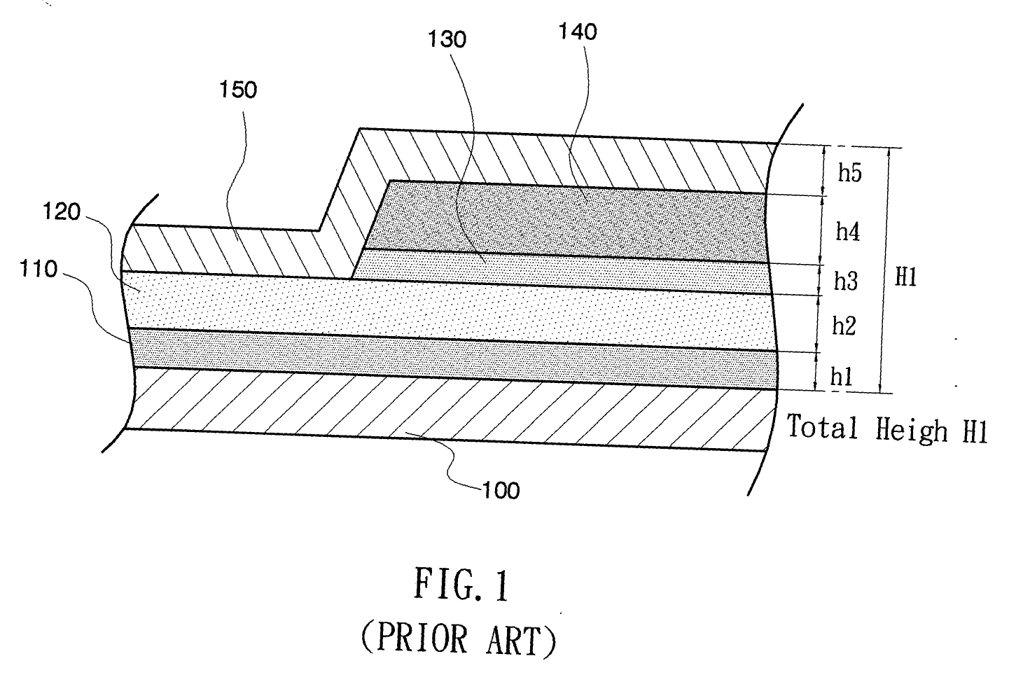

Now referring to FIG. 1, a cross sectional view of a thin film transistor (TFT) structure on an array substrate of a conventional LCD device is depicted therein. The TFT structure on the array substrate is generally formed by mask-based technology known in the field, such as exposure, development and etching processes. The TFT structure comprises a gate layer 110 (having a height h1 of 0.40 μm) formed as a portion of a gate line on a substrate 100, a gate insulating layer 120 (having a height h2 of 0.40 μm), a semiconductor layer 130 (having a height h3 of 0.18 μm), a source and drain layer 140 (having a height h4 of 0.40 μm) and an insulating layer 150 (having a height h5 of 0.30 μm), formed from bottom to top. These layers 110,120,130,140,150 are each formed by the mask-based process with a corresponding mask used for each layer, and compose a structure having a total height H1 of 1.68 μm. For a convenient purpose, the structure is referred to as a TFT structure A hereinbelow.

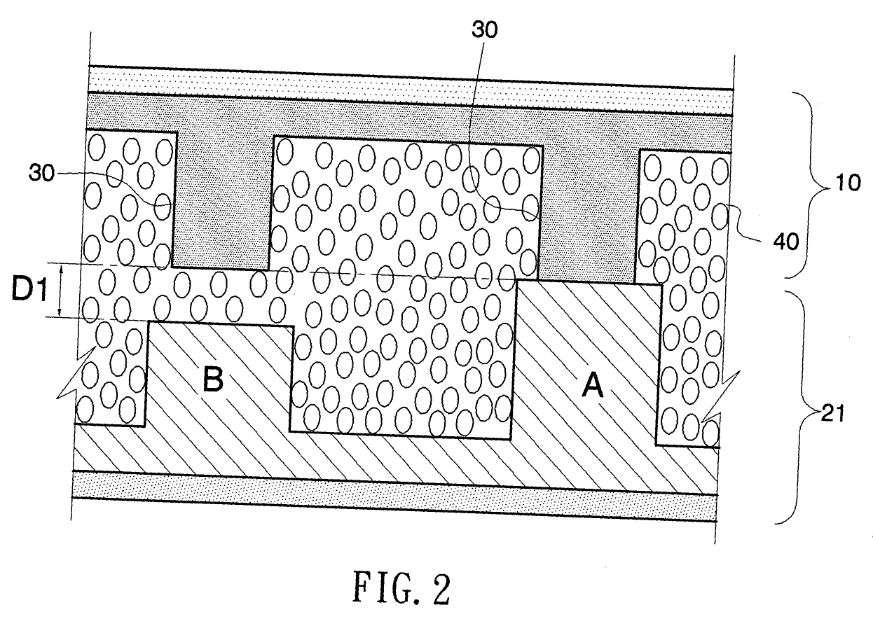

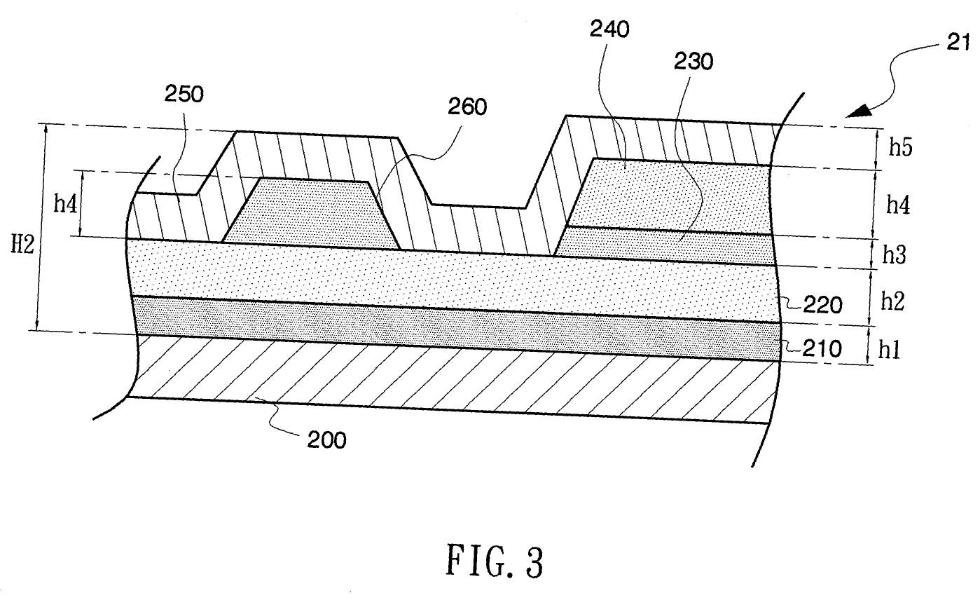

Next, referring to FIG. 2 and FIG. 3, a schematic diagram of assembly and a cross sectional view of structure of an LCD device according to a first embodiment of the present invention are depicted therein, respectively. The LCD device comprises an array substrate 21, a color filter substrate 10, and a LC layer 40 sandwiched between the array and color filter substrates 21, 10. On a substrate 200 of the array substrate 21, a gate layer 210, a gate insulating layer 220, a semiconductor layer 230, a first source and drain layer 240, an insulating layer 250 and a second source and drain layer 260 are formed from bottom to top by the mask-based process. These layers 210, 220, 230, 240, 250, 260 are each formed by the mask-based process with a corresponding mask used for each layer, the second source and drain layer 260 and the insulating layer 250 on the gate insulating layer 220 compose a protrusion B. To form such protrusion, when the first source and drain layer 240 is to be formed, a rectangular opening is provided on a mask for forming the first source and drain layer 240 at a structure corresponding to a gate line on the array substrate so as to additionally form the second source and drain layer 260 between the gate insulating layer 220 and the insulating layer 250, i.e., the protrusion B, having the same height as that of the first source and drain layer 240 (h4=0.40 μm) between the gate insulating layer 220 and a contact hole of the gate line, with a dimension so that the protrusion B may sufficiently support a spacer 30 corresponding thereto. The protrusion B has a height H2 of 1.50 μm and is thus shorter by 0.18 μm as compared to the TFT structure A. Therefore, when the color filter substrate 10 having the spacers 30 and the array substrate 21 with the protrusion B and the TFT structure A are assembled, a height difference D1 of 0.18 μm is obtained with respect to a space between the protrusion B and the spacer 30 corresponding thereto and a space between the TFT structure A and a spacer 30 corresponding thereto.

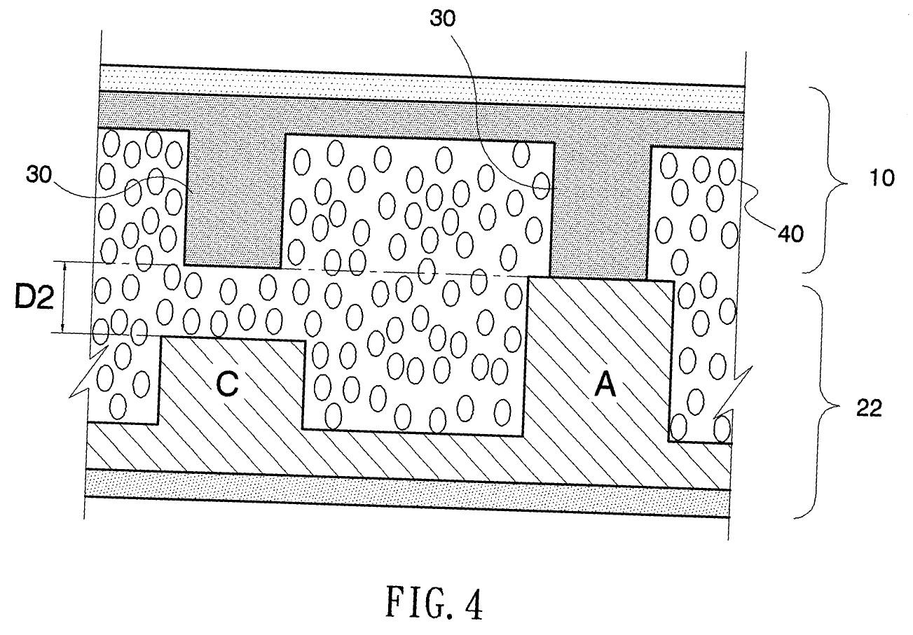

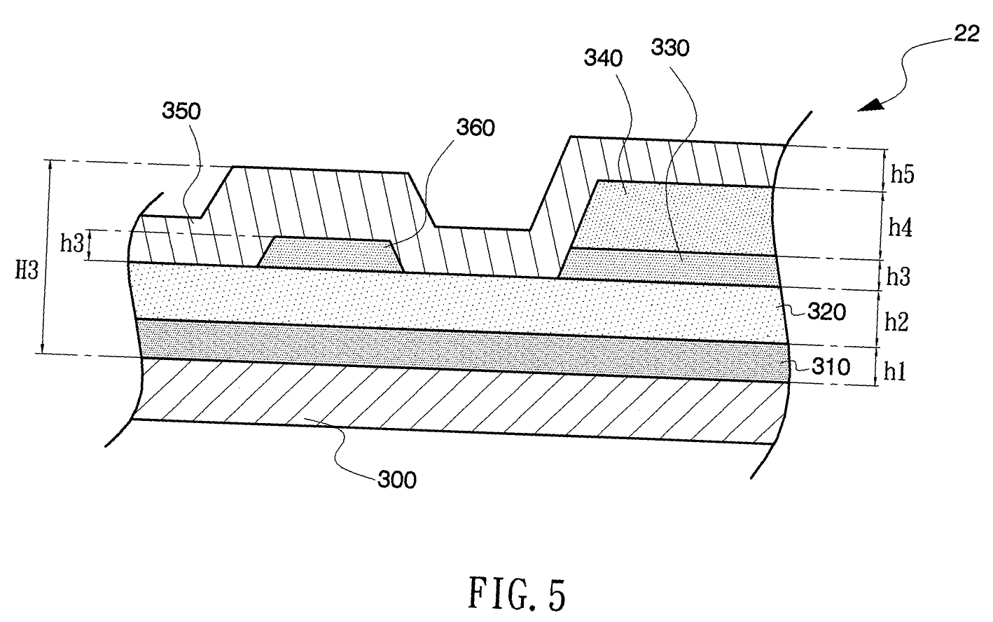

Next, referring to FIG. 4 and FIG. 5, a schematic diagram of assembly and a cross sectional view of structure of the LCD device according to a second embodiment of the present invention are depicted therein, respectively. The LCD device comprises an array substrate 22, a color filter substrate 10, and a LC layer 40 sandwiched between the array and color filter substrates 22, 10. On a substrate 300 of the array substrate 22, a gate layer 310, a gate insulating layer 320, a first semiconductor layer 330, a source and drain layer 340, an insulating layer 350 and a second semiconductor layer 360 are formed from bottom to top by the mask-based process. These layers 310, 320, 330, 340, 350, 360 are each formed by the mask-based process with a corresponding mask used for each layer and the second semiconductor layer 360 and the insulating layer 350 on the gate insulating layer 320 compose a protrusion C. To form such protrusion, when the first semiconductor layer 330 is to be formed, a rectangular opening is provided on a mask for forming the first semiconductor layer 330 at a structure corresponding to a gate line on the array substrate 22 so as to additionally form the second semiconductor layer 360 between the gate insulating layer 320 and the insulating layer 350, i.e., the protrusion C, having the same height as that of the first semiconductor layer 330 (h3=0.18 μm) between the gate insulating layer 320 and a contact hole of the gate line, with a dimension so that the protrusion C may sufficiently support a spacer 30 corresponding thereto. The protrusion C has a height H3 of 1.28 μm and is thus shorter by 0.40 μm as compared to the TFT structure A. Therefore, when the color filter substrate 10 having the spacers 30 and the array substrate 22 with the protrusion C and the TFT structure A are assembled, a height difference D2 of 0.40 μm is obtained with respect to a space between the protrusion C and the spacer 30 corresponding thereto and a space between the TFT structure A and a spacer 30 corresponding thereto.

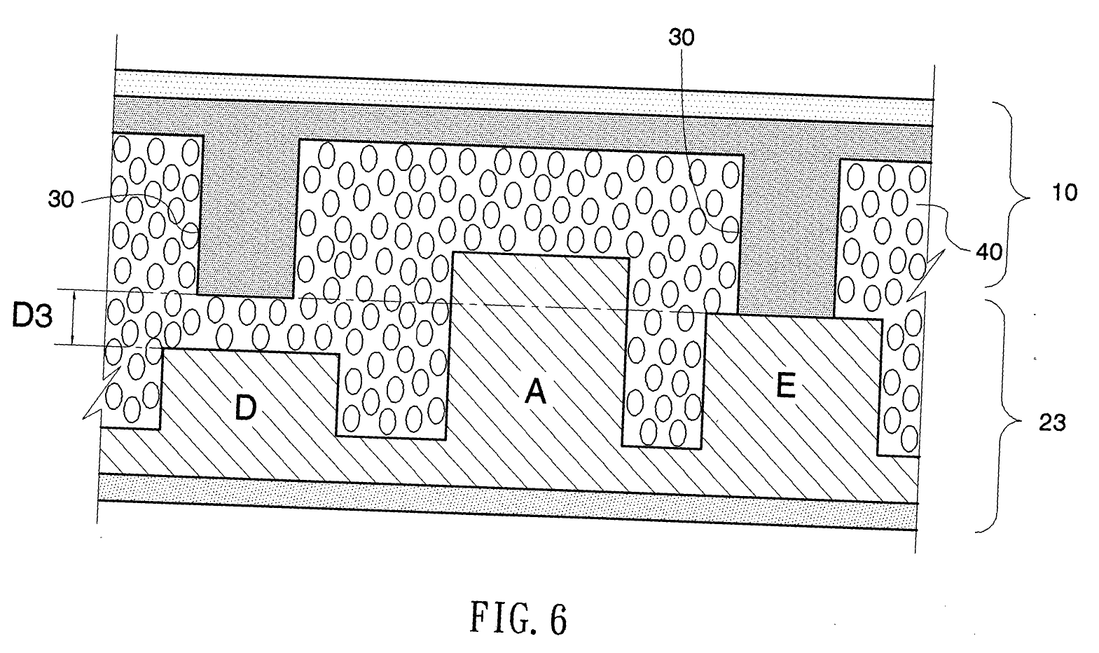

Referring to FIG. 6, a schematic diagram of assembly of the LCD device according to a third embodiment of the present invention is depicted therein, which is obtained with combination of the concepts of the first and second embodiments, i.e., the second semiconductor layer and the second source and drain layer in the first and second embodiments are provided in the LCD device concurrently. In this embodiment, to form the second semiconductor layer and the second source and drain layer, a rectangular opening is provided on the mask for forming the first semiconductor layer and a rectangular opening is provided on the mask for forming the first source and drain layer at a structure corresponding to a gate line on the array substrate, so as to additionally form the second semiconductor layer, having a height h3 of 0.18 μm, and the second source and drain layer, having a height h4 of 0.40 μm, between the gate insulating layer and the insulating layer, i.e. a first protrusion D and a second protrusion E, respectively. The dimensions of the rectangular openings are devised in such a manner that the protrusions D and E may sufficiently support spacers 30 corresponding thereto, respectively. The first and second protrusions D and E may be seen in FIG. 5 and FIG. 2, respectively, and have heights H3 and H2 of 1.28 μm and 1.50 μm, respectively. Between the first and second protrusions D and E has a height difference of 0.22 μm. Therefore, when the color filter substrate 10 having the spacers 30 and the array substrate 23 having the protrusions D and E are assembled together, a space between the protrusion D and the spacer 30 corresponding thereto and the protrusion E and the spacer 30 corresponding thereto have a height difference D3 of 0.22 μm. In addition, as compared to the TFT structure A, the first and second protrusions D and E have smaller heights by 0.18 μm and 0.40 μm, respectively. Therefore, when the color filter substrate 10 having the spacers 30 and the array substrate 23 having the protrusions D and E and the TFT structure A are assembled together, a space between the protrusion D and the spacer 30 corresponding thereto and a space between the protrusion E and the spacer 30 corresponding thereto have height differences of 0.18 μm and 0.40 μm, respectively, compared with a space between the TFT structure A and a spacer 30 corresponding thereto.

In each of the above mentioned embodiments, the rectangular opening is provided in the mask for forming the source and drain layer or the semiconductor layer so as to form the protrusion in a stripe shape to mate with the corresponding spacer. The opening in the mask may also be in other shapes so as to mate with other forms of spacer, such as spherical spacers. Further, the dimension of the protrusion may not be limited as used above, the dimension of the protrusion may be 4 to 8 μm greater than that of the spacer for the above embodiments.

In the above embodiments, the platforms in the form of protrusions on the array substrate 23 are slightly greater than the spacers in area. However, these platforms may be made smaller than and in different shapes compared with the spacers corresponding thereto, which will be described below.

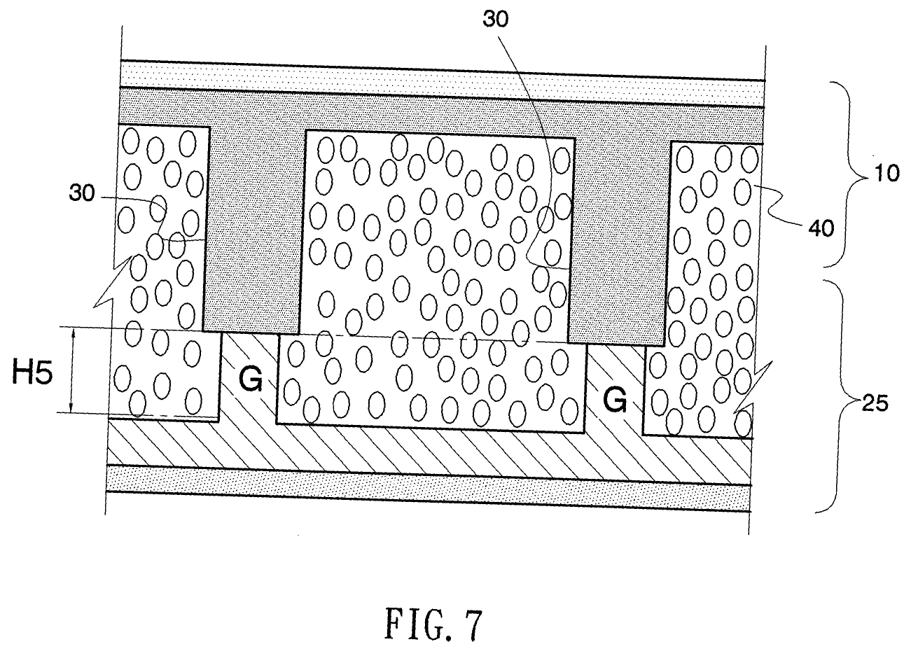

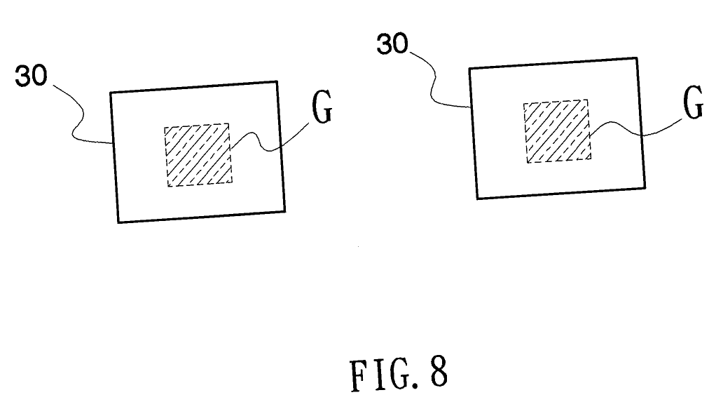

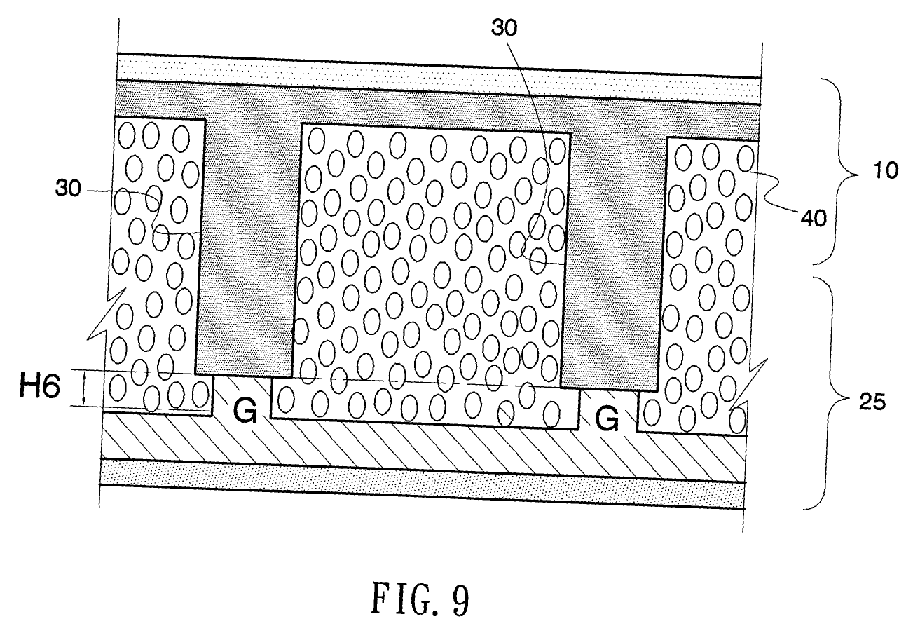

Referring to FIG. 7 and FIG. 8, a schematic diagram of assembly and a cross sectional view of structure of the LCD device according to a third embodiment of the present invention are depicted therein, respectively. This embodiment is identical to the second embodiment except for the portion specifically indicated as follows. A rectangular opening is provided in a subject mask (referring to the above embodiments) in such a manner that the thus formed protrusion G has a smaller area as compared to the spacer 30 corresponding thereto. When the color filter substrate 10 and the array substrate 25 are assembled together, the spacers 30 may be exerted with a pressure. Since the platform in the form of a protrusion G having a height H5 of 0.18 μm is formed on the array substrate 25, a space margin of a height H6 of 0.03 μm is provided between the protrusion G and the spacer 30 corresponding thereto (see FIG. 9). With the provision of the space margin, the spacers 30 are allowed to be pressed down up to the height H6 of 0.03 μm. As such, the spacers 30 may be prevented from being not capable of restoring to their original heights, i.e. getting deformed and leading to a cause for poor display characteristics when being subject to an external force.

Furthermore, bubble forming of the LC material due to shrinkage thereof at a lower temperature may be prevented with the provision of the space margin.

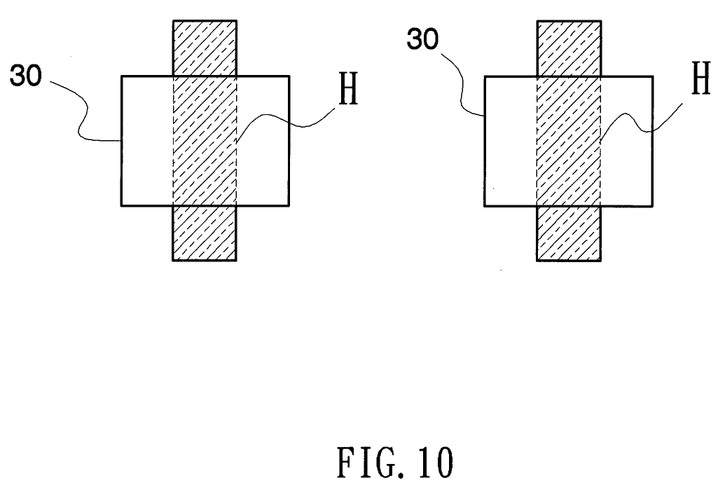

Referring to FIG. 10, a top view of the LCD device according to a fifth embodiment of the present invention is depicted therein. This embodiment is identical to the foregoing embodiments except for the portion specifically indicated as follows. In this embodiment, the rectangular opening provided in the mask is made longer than that of the spacer and thus the formed protrusion H also has a greater length than the spacer 30. As such, the result of the greater protrusion than the spacer 30 in the foregoing embodiments may also be achieved.

In conclusion, the invention provides platforms in the form of protrusions of different heights on an array substrate of an LCD device, such as the protrusions B, C and the first and second protrusions D and E, or platforms of different areas or shapes, such as the protrusion G and H, to support the spacers corresponding thereto. So that, the different predetermined spaces may be provided between the spacers and the array substrate and thus an equivalent result of the spacers of different heights in the prior art may be achieved at the same time the problems and disadvantages encountered in the prior art are overcome. Namely, bubble forming of the LC material due to shrinkage thereof at a lower temperature may be prevented. Further, the spacers on the color filter substrate may not get deformed when being subject to an external force with the provision of the inventive protrusions on the array substrate. As such, number of masks required or forming the array substrate with the protrusions may not be increased and even manufacturing time and cost therefor may not be increased.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims and their equivalents.

What is claimed is:

1. A liquid crystal display (LCD) device, comprising:
a color filter substrate having a plurality of first and second spacers provided thereon;
a thin film transistor (TFT) array substrate having a plurality of first and second protrusions corresponding to said plurality of first and second spacers; and
a liquid crystal (LC) layer, having a LC material filled therein, sandwiched between said color filter substrate and TFT array substrate
wherein said plurality of first spacers and said plurality of first protrusions are brought into contact with each other and said plurality of second spacers and said plurality of second protrusions are also brought into contact with each other while a space margin is provided between them and said TFT array substrate.

2. The LCD device according to claim 1, wherein each of said plurality of first spacers includes a spherical spacer and a spacer on color filter (SOC).

3. The LCD device according to claim 1, wherein each of said plurality of second spacers includes a spherical spacer and a spacer on color filter (SOC).

4. The LCD device according to claim 1, wherein each of said portion of said plurality of first protrusions has a width greater than that of a corresponding one of said portion of said plurality of first spacers by 4 to 8 μm.

5. The LCD device according to claim 1, wherein each of said portion of said plurality of second protrusions has a width greater than that of a corresponding one of said portion of said plurality of second spacers by 4 to 8 μm.

6. The LCD device according to claim 1, wherein each of said portions of said plurality of first protrusions has an area greater than that of a corresponding one of said portion of said plurality of first spacers.

7. The LCD device according to claim 1, wherein each of said portions of said plurality of second protrusions has an area greater than that of a corresponding one of said portion of said plurality of second spacers.

8. The LCD device according to claim 1, wherein each of said portions of said plurality of first protrusions has an area smaller than that of a corresponding one of said portion of said plurality of first spacers.

9. The LCD device according to claim 1, wherein each of said portions of said plurality of second protrusions has an area smaller than that of a corresponding one of said portion of said plurality of second spacers.

10. The LCD device according to claim 1, wherein each of said portions of said plurality of first protrusions has a length greater than that of a corresponding one of said portion of said plurality of first spacers.

11. The LCD device according to claim 1, wherein each of said portions of said plurality of second protrusions has a length greater than that of a corresponding one of said portion of said plurality of second spacers.
